(19) United States
(12) Patent Application Publication
(10) Pub. No.: US 2004/0017264 A1
(43) Pub. Date: Jan. 29, 2004

(54) High frequency transmission cable

(75) Inventor: Che-Chia Chang, Taipei (TW)

Correspondence Address: BRUCE H. TROXELL, 5205 LEESBURG PIKE, SUITE 1404, FALLS CHURCH, VA, 22041, US

(73) Assignee: COMAX TECHNOLOGY INC.

(21) Appl. No.: 10/205,415

(22) Filed: Jul. 26, 2002

(51) Int. Cl. H01P 5/00

(52) U.S. Cl. 333/1

(57) ABSTRACT

A high frequency transmission cable includes one or more propagation channel sets, an inner covering wrapping the propagation channel sets and providing an effect of shield, drain wires and a jacket. Two conductors in each of the propagation channels are joined to each other tightly as a single piece to perform communication of electrical appliances in a way of the conductor pair juxtaposing and being flush with each other surely for avoiding signals transmitted in the conductors becoming not synchronous due to the conductors being in inconsistent length resulting from the cable being bent so as to enhance the frequency width of the transmission cable.

### BACKGROUND OF THE INVENTION

1. Field of the Invention

The present invention relates to a high frequency transmission cable and, in particular, to a high frequency transmission cable with conductors in the propagation channels thereof being kept juxtaposed and equal in lengths.

2. Description of Related Art

Due to functions of the central processing unit of a computer having been upgraded, the net bandwidth increasing and storage medium data rising tremendously, both the input and output interfaces of the periphery are getting necessary to provide larger bandwidth so that the standard for wide band transmission cables are regulated largely like bamboo shoots after spring. However, problems, such as transmission delay, impedance matching, cross talk, ground noise control and electromagnetic wave radiation interference, resulting from high frequency signals are getting serious in the transmission cables along with the increased bandwidths of the transmission cables.

As for the transmission interfaces in a computer, Serial ATA, the serial transmission equipment, is a transmission cable providing with the highest bandwidth at the present time. Because the Serial ATA has two conductors, i.e., a transmission pair, being used as a transmission channel set for transmitting differential NRZ signal, the conductors in the same transmission channel being very much different from each other in their lengths causes signals transmitted at the same time from the input end being not possible to reach the output end simultaneously in the process of signal transmission. That is, the signals emitted from the input end are possible to be received synchronously.

The difference value of relative propagation delay between two conductors in the field of testing differential signal transmission cables, i.e., the so-called intra pair skew, as shown in FIG. 5, is defined as that a positive signal and a negative signal are transmitted from the input end to the output end via two conductors respectively and transmission time durations t1, t2 for the two signals are measured with the test standard for the transmission based on the signal pulse reaching a middle voltage value and the difference value of the two transmission time durations |t1-t2| is the intra pair skew.

For a conventional cable used for transmitting low frequency signal, the transmission quality affected by inconsistent lengths of the conductors therein is inconspicuous. However, while the frequency of the signal loaded in the transmission cable increases, especially, to more than 1 GHz, the inversed propagation delay between output ends is close to the frequency of the signal and the intra pair skew can affect the quality of the output signal directly. Hence, the influence brought with the intra pair skew is significantly and it becomes a key factor of bandwidth limitation to the conductors.

Referring to FIG. 1, the currently used high frequency cable mainly has two transmission channel sets 10a, 10a′ and each of the transmission channel sets 10a, 10a′ includes two independent conductors 11a, 11a′, a drain wire 30a disposed at two opposite lateral sides of the transmission channel set 10a, 10a′, an inner covering 20a providing an effect of shield and wrapping both outer sides of the conductors 11a, 11a′ and the drain wire 30a with a conductive layer 21a and an insulation layer 22a from the inner side to the outer side thereof and a jacket 40a covering the inner covering 20a to constitute a high frequency cable.

But, the preceding transmission cable has the following problem in practice. For being stored up or delivered handily after having been fabricated, the transmission cable is coiled up. But, the two conductors in the transmission channel easily displace because of being bent during the process of coiling such that it is not easy to control the conductors in their lengths in case of being cut and as soon as the transmission cable is connected to connectors and the transmission channel therein is loaded with high frequency signals, it results in an excessive large intra pair skew due to the two conductors being unequal in their lengths such that it is unable for the output end to receive the signals synchronously and the bandwidth of the transmitting frequency is limited.

### SUMMARY OF THE INVENTION

Accordingly, an object of the present invention is to provide a high frequency transmission cable to secure the conductors in every propagation channel being kept juxtaposed and equal lengths even if the transmission cable is bent instead of the two conductors being misplaced and unequal as the prior art does so that the propagation delay at the output end can be reduced to enhance the bandwidth of the signal in the transmission cable.

In order to reach the preceding object, the high frequency transmission cable has two conductors in each propagation channel set being wrapped tightly as a single piece to perform communication of electrical appliances in a way of the conductor pair really being juxtaposed and flush with each other for avoiding signals transmitted in the conductors becoming not synchronous due to the conductors being in inconsistent lengths resulting from the cable being bent so as to enhance the frequency width of the transmission cable.

### BRIEF DESCRIPTION OF THE DRAWINGS

The present invention can be more fully understood by reference to the following description and accompanying drawings, in which:

FIG. 1 is a sectional view of a conventional transmission cable;

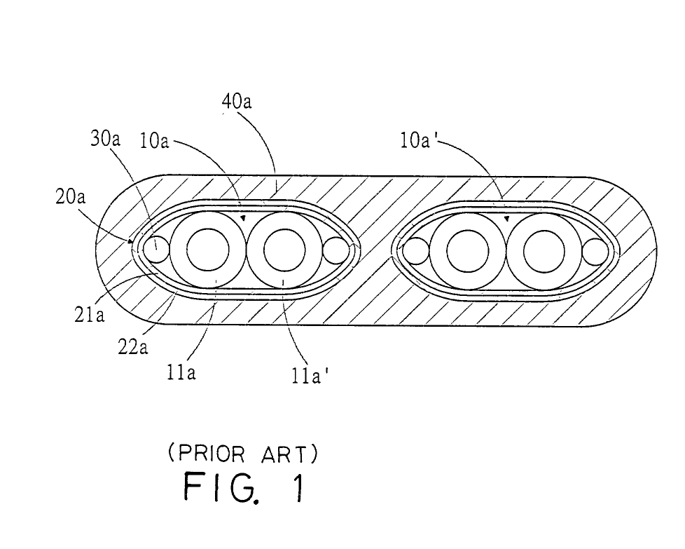

FIG. 2 is a sectional view of a transmission cable according to the present invention in an embodiment thereof;

FIG. 3 is a sectional view of another embodiment of the present invention;

FIG. 4 is a sectional view of a further embodiment of the present invention; and

FIG. 5 is a schematic diagram illustrating transmission time difference between two lead cables.

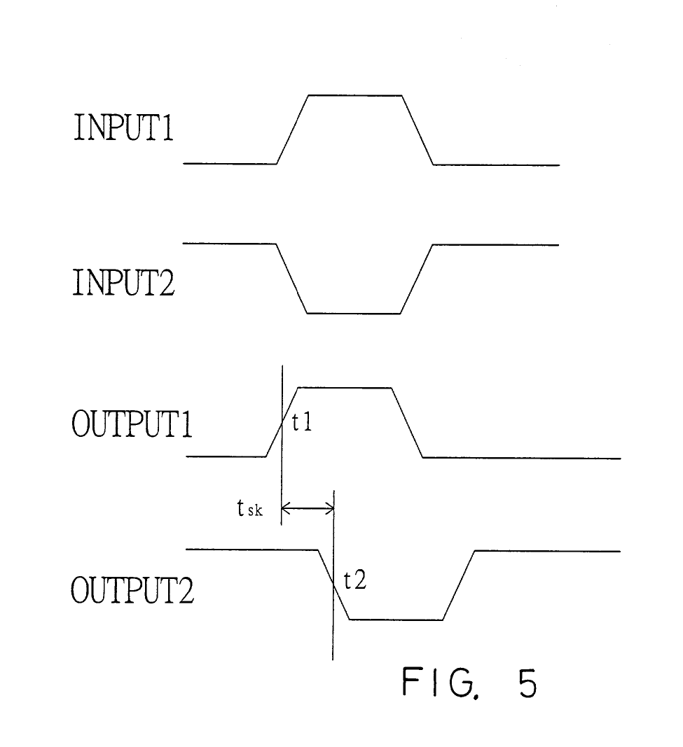

### DETAILED DESCRIPTION OF THE PREFERRED EMBODIMENT

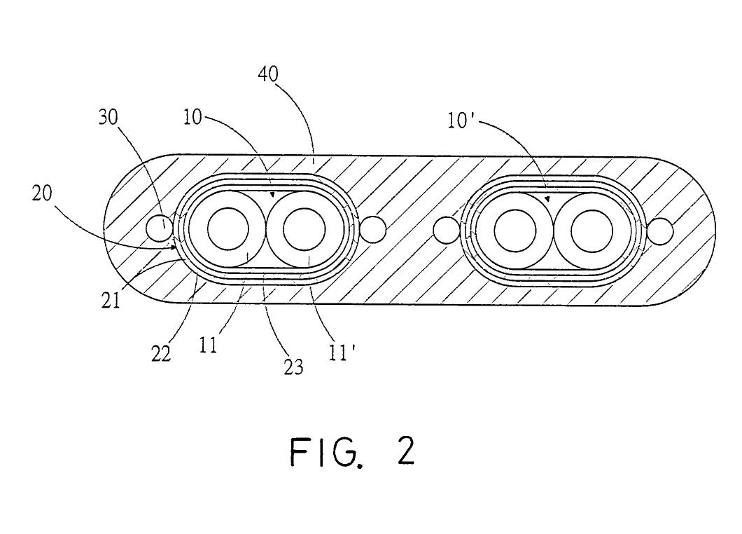

Referring to FIG. 2, a high frequency transmission cable comprises one or more propagation channel sets 10, 10′ for carrying out communication of electric appliances, a respective inner covering 20 for covering and protecting each propagation channel set 10, 10′, a drain wire 30 and a jacket 40. Each propagation channel set 10, 10′ has a pair of conductors 11, 11′ being tightly joined or tied together as a single piece to secure the pair of conductors 11, 11′ being juxtaposed and flush with each other for avoiding signals transmitted in the conductors 11, 11′ becoming not synchronous due to inconsistent lengths resulting from the cable being bent. In this way, it is capable of enhancing the bandwidth of the transmission cable.

The preceding each propagation channel set 10, 10′ has the conductors 11, 11′ to form a transmission pair for transmitting differential NRZ signals such that one conductor 11 can transmit positive electrical signal and the other conductor 11′ can transmit negative electrical signal. Further, the inner covering at least contains an insulation layer 22, a conductive layer 21 distributing over the insulation layer 22 for preventing from shield caused by the electromagnetic interference and a locating layer 23 for fixing the conductors. The conductive layer 21 can be a gold foil, a silver foil or aluminum foil. The inner covering 20 at two outer lateral sides thereof is arranged with a drain wire 30 respectively such that external interference can be isolated from the internal transmission signals by way of the inner covering and the drain wire.

While the cable is made, two independent conductors 11, 11′ are prepared and are arranged to juxtapose to each other with being flattened tightly by a preset tension force. Then, a strip insulator is provided with a facial side thereof paved with conductive layer 21 such as an aluminum foil and the other facial side thereof distributed with thermo-melting plastics. The thermo-melting plastic material such as Form PE or Form PP is the same material as the insulation plastic covering at the outer layer of the conductor 11. Of course, PE or PP can be used instead of Form PE or Form PP. Next, the two conductors 11, 11′ are coiled up or enclosed with the strip insulator tightly with the thermo-melting plastic material part being arranged as the inner side the strip insulator. The conductors 11, 11′ are heated up immediately right after being coiled up or enclosed with the strip insulator so that the thermo-melting plastic material melts to join with the insulation plastic covering as a locating layer 23 so as to form the inner covering 20. Further, the drain wire 30 is disposed at two lateral sides of the shield. Finally, the jacket 40 is formed by way of PVC, PE or PP being injection molded to cover the entire conductors 11, 11′. Hence, a high frequency transmission cable with the conductor pair 11, 11′ being in a state of juxtaposing and being equal in their lengths can be fixed up completely.

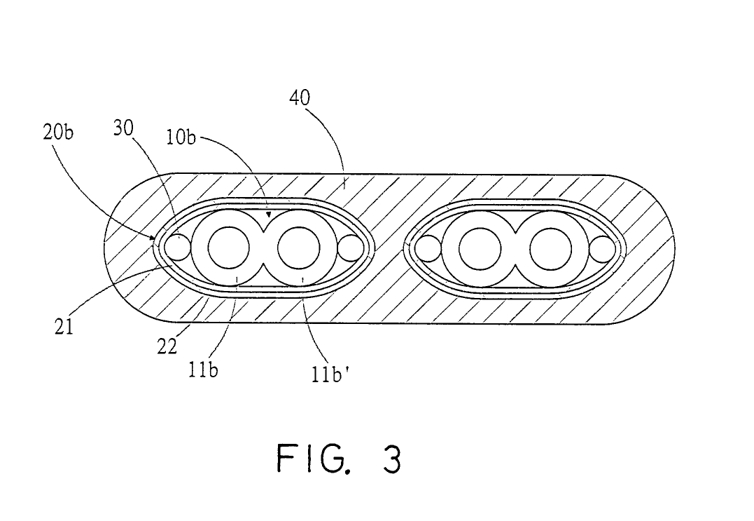

Besides, referring to FIG. 3, another embodiment of the present invention is illustrated. While the cable is made, two conductors 11b, 11b′ are fabricated as a set by way of wiring arrangement to form a propagation channel 10b for carrying out communication job of electrical appliances. The two conductors 11b, 11b′ are juxtaposed to each other with being flattened tightly by a preset tension force. Then, a strip insulator layer 22 is provided with a facial side thereof paved with a conductive layer 21 such as an aluminum foil. The two conductors 11b, 11b′ are wrapped by a coiled strip insulator tightly with a facial side thereof having metal material being as the outer side. In this way, the inner covering 20b is formed after the two conductors 11b, 11b′ being enclosed completely. Further, at least a drain wire 30 next to the conductive layer 21 is attached to the inner covering at the outer side thereof. Finally, the jacket 40 is formed by way of PVC, PE or PP being injection molded to cover the entire conductors 11b, 11b′. Hence, a high frequency transmission cable with conductor pair 11b, 11b′ being juxtaposed and equal in their lengths can be fixed up completely.

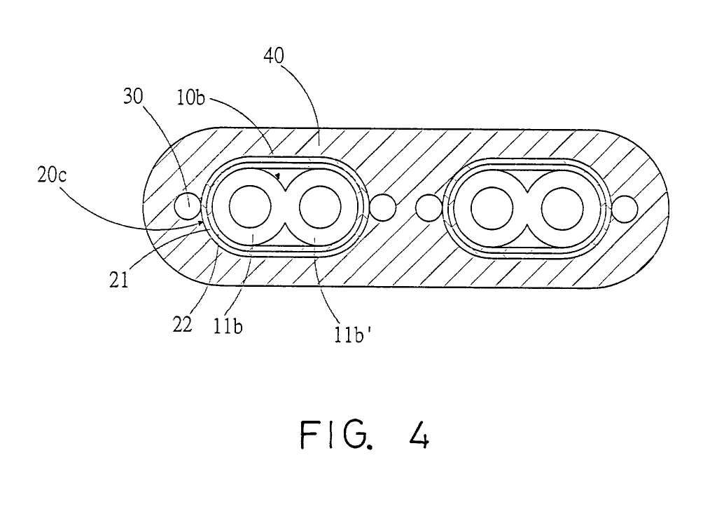

Furthermore, referring to FIG. 4, a further embodiment of the present invention is illustrated. While the cable is made, two conductors 11b, 11b′ are fabricated as a pair by way of wiring arrangement to form a propagation channel 10 for carrying out communication job of electrical appliances. The two conductors 11b, 11b′ are juxtaposed to each other with being flattened tightly by a preset tension force. Then, a strip insulator layer 22 is provided with a facial side thereof paved with a conductive layer 21 such as an aluminum foil. The two conductors 11b, 11b′ are wrapped by the strip insulator tightly with a facial side thereof attached with metal material being as the inner side thereof. In this way, the inner covering 20b is formed after the two conductors 11b, 11b′ being wrapped completely. Further, at least a drain wire 30 next to the conductive layer 21 is attached to the inner covering 20b at the outer side thereof. Finally, the jacket 40 is formed by way of PVC, PE or PP being injection molded to cover the entire conductors 11b, 11b′. Hence, a high frequency transmission cable with juxtaposed and equal length conductor pair 11b, 11b′ can be fixed up completely.

As the foregoing, the conductors of the propagation channel according to the present invention can be joined to each other as an integral piece by way of a locating layer or wiring arrangement to keep the two conductors being juxtaposed instead of being misplaced or inconsistent in lengths. In this way, it is possible to reduce the time difference between the output ends of the transmission pair effectively during the signal being transmitted by way of the cable so as to increase the frequency width thereof.

While the invention has been described with reference to the a preferred embodiment thereof, it is to be understood that modifications or variations may be easily made without departing from the spirit of this invention, which is defined by the appended claims.

What is claimed is:

1. A high frequency transmission cable, comprising
one or more propagation channel sets, each of the propagation sets further comprising two independent conductors for carrying out communication of electrical appliances;
an inner covering, covering the propagation channel, having a locating layer, an insulation layer and a conductive layer being disposed from an inner side to an outer side thereof sequentially;
at least a drain wire, being disposed outside the inner covering next to the conductive layer; and
a jacket, being an outermost layer for protecting the cable;
whereby, the two conductors in each of the propagation channel sets are joined to each other as a single piece by way of the locating layer to secure the pair of conductors being juxtaposed and flush with each other for avoiding signals transmitted in the conductors becoming not synchronous due to the conductors being in inconsistent length resulting from the cable being bent so that it is capable of enhancing the frequency width of the transmission cable.

2. The high frequency transmission cable as defined in claim 1, wherein the locating layer is made of thermo-melting plastics.

3. The high frequency transmission cable as defined in claim 1, wherein the inner covering is formed by way of a strip material enwinding and wrapping the two conductors.

4. The high frequency transmission cable as defined in claim 1, wherein the jacket is made of PVC, PE or PP.

5. The high frequency transmission cable as defined in claim 1, wherein the conductive layer is a gold foil, silver foil or aluminum foil.

6. A high frequency transmission cable, comprising:
one or more propagation channel sets, each of the propagation sets further comprising two conductors fabricated with wiring arrangement for carrying out communication of electrical appliances;
an inner covering, wrapping the propagation channel, and having an insulation layer and a conductive layer;
at least a drain wire, being disposed next to the conductive layer; and
a jacket, being an outermost layer for protecting the cable;
whereby, the two conductors in each of the propagation channel sets are joined to each other as a single piece by way of the wiring arrangement to secure the pair of conductors being juxtaposed and flush with each other for avoiding signals transmitted in the conductors becoming not synchronous due to the conductors being in inconsistent length resulting from the cable being bent so as to enhance the frequency width of the transmission cable.

7. The high frequency transmission cable as defined in claim 6, wherein the insulation layer is arranged at an inner side of the conductive layer and the drain wire is disposed in the inner covering.

8. The high frequency transmission cable as defined in claim 6, wherein the insulation layer is arranged at an outer side of the conductive layer and the drain wire is disposed outside the inner covering.

9. The high frequency transmission cable as defined in claim 6, wherein the inner covering is formed by way of a strip material enwinding and wrapping the two conductors.

10. The high frequency transmission cable as defined in claim 6, wherein the jacket is made of PVC, PE or PP.

11. The high frequency transmission cable as defined in claim 6, wherein the conductive layer is a gold foil, silver foil or aluminum foil.
